(19) United States
(12) Patent Application Publication
(10) Pub. No.: US 2016/0221526 A1
(43) Pub. Date: Aug. 4, 2016

(54) INFLATABLE AIRBAG OF A CURTAIN AIRBAG, AIRBAG MODULE, VEHICLE OCCUPANT RESTRAINT SYSTEM AND CURTAIN AIRBAG

(71) Applicant: Dalphi Metal Espana S.A., Madrid (ES)

(72) Inventor: Pedro Jose Santin Navarro, Vigo (ES)

(21) Appl. No.: 15/011,783

(22) Filed: Feb. 1, 2016

(30) Foreign Application Priority Data
Feb. 3, 2015 (DE) 202015000764.3

(51) Int. Cl. B60R 21/232; B60R 21/213

(52) U.S. Cl. CPC B60R 21/232; B60R 21/213

(57) ABSTRACT

The invention relates to an inflatable airbag (10) of a curtain airbag comprising an upper edge (11) and a lower edge (12), comprising a front side window portion (13) and a rear side window portion (14) as well as an inner layer (16) facing the interior compartment and an outer layer (16) facing the side windows (45). In accordance with the invention, the airbag (10) includes at least one mechanical reinforcing element (20, 20′) which in the inflated state of the airbag (10) is arranged to be spaced both from the upper edge (11) and from the lower edge (12) in a central area (17) of the height (H) of the airbag (10), the mechanical reinforcing element (20, 20′) being strip-shaped.

### BACKGROUND OF THE INVENTION

The invention relates to an inflatable airbag of a curtain airbag comprising an upper edge and a lower edge, comprising a front side window portion and a rear side window portion as well as an inner layer feeing the interior and an outer layer feeing the side windows. Apart from that, the invention relates to an airbag module, a vehicle occupant restraint system and a curtain airbag.

Curtain airbags for vehicles are known from the state of the art. Airbags of this type prevent injuries of the vehicle occupant in the head area in the case of side impact it has turned out, however, that the currently known systems require a high inflation gas pressure over a relatively long time to offer sufficient protection to the occupants of the vehicle in the case of roll-over of the vehicle.

### SUMMARY OF THE INVENTION

It is an object of the present invention to further develop an inflatable airbag of a curtain airbag so that improved protection for a head of the occupant is achieved. It is a further object to state an airbag module, a vehicle occupant restraint system as well as a curtain airbag comprising an airbag developed in this way.

In accordance with the invention, this object is achieved with respect to the airbag by the subject matter of claim 1, with respect to the airbag module by the subject matter of claim 13, with respect to the vehicle occupant restraint system by the subject matter of claim 14 and with respect to the curtain airbag by the subject matter of claim 15. Therefore the invention provides a reliable protection for an occupant's head in the case of vehicle roll-over even in cases of low or no gas pressure in the air bag.

Advantageous and expedient configurations of the airbag according to the invention are stated in the subclaims.

It is started from an inflatable airbag of a curtain airbag comprising an upper edge and a lower edge, comprising a front side window portion and a rear side window portion as wall as an inner layer facing the interior compartment and an outer layer facing the side windows. As is known, a curtain airbag consists of a coherent airbag which is confined in the direction of the vehicle roof by an upper edge and in the direction of the lower door edge by a lower edge. With the aid of the curtain airbag plural side window portions are covered upon triggering the airbag. This relates to both a front side window and at least one rear side window. The front side window is formed either level with a driver or level with a passenger. Moreover, it can be provided that a curtain airbag covers plural rear side windows. In the case of a van, for example, plural rear side windows are provided which are adapted to be covered with the aid of a curtain airbag in the trigger case.

An airbag comprises at least two airbag layers, an inner layer facing the interior compartment and an outer layer of the airbag facing the side windows. Between the outer layer and the inner layer gas flows into the airbag in the activated state and forms a limited gas volume there for the protection of body parts, especially for the protection of the head of a vehicle occupant.

In accordance with the invention, the inflatable airbag of a curtain airbag includes at least one mechanical reinforcing element arranged in the inflated state of the airbag to be spaced both from the upper edge and from the lower edge in a central area of the height of the airbag, the mechanical reinforcing element being strip-shaped. The height of the airbag is formed by the distance of the upper edge from the lower edge of the inflatable airbag. According to the invention, in the central area of the height at least one mechanical reinforcing element is configured which is strip-shaped. By the central area of the height of the airbag such height is meant which brings about sufficient distance of the mechanical reinforcing element both from the upper edge and from the lower edge. For example, the mechanical reinforcing element configured In strip or elongate shape is arranged in an area of the airbag which, based on the upper edge of the inflatable airbag, corresponds to 30 to 80%, especially 40 to 85%, especially 50 to 80%, of the height of the airbag.

Due to the strip-shaped mechanical reinforcing element configured, in the case of vehicle roll-over and possibly a broken side window the head of a vehicle occupant is prevented from being thrown out of the vehicle interior.

The at least one mechanical reinforcing element can be formed and fastened between the inner layer and the outer layer. In other words, the mechanical reinforcing element is formed and fastened inside the airbag, viz. in the interior formed by the inner layer and the outer layer of the airbag, for example. This offers the advantage, e.g. when rolling up or folding the airbag, that the mechanical reinforcing element is rolled in and folded inside the airbag so that exterior damage of the mechanical reinforcing element is prevented.

Moreover, it is possible that at least one mechanical reinforcing element is fastened to the outer layer of the airbag. In the inflated state of the airbag the mechanical reinforcing element is arranged directly on the outer layer of the inflatable airbag so that the head of a vehicle occupant does not directly impact on a harder mechanical reinforcing element in the inflated state of the airbag. Consequently, fastening the mechanical reinforcing element to the outer layer of the airbag is a fastening position which is gentle to the vehicle occupant.

In a preferred embodiment of the invention, the at least one mechanical reinforcing element is formed merely in the rear side window portion. By the rear side window portion both only one rear side window and plural rear side windows can be covered, in other words, the strip-shaped or elongate mechanical reinforcing element is located merely in the rear side window portion of the curtain airbag so that the front side window portion of the inflatable airbag includes no mechanical reinforcing element.

In an embodiment of the invention, the at least one mechanical reinforcing element has such length that the mechanical reinforcing element in the inflated state of the airbag extends between the B pillar and the C pillar of a vehicle. Accordingly, the mechanical reinforcing element has at least a length that corresponds to the distance of a B pillar from the C pillar of a vehicle.

In another embodiment of the invention, the at least one mechanical reinforcing element has such length that in the inflated state of the airbag it covers at least in portions the B pillar and the C pillar. Preferably the mechanical reinforcing element thus has such length that the mechanical reinforcing element at least in portions rests both on the B pillar and on the C pillar in the inflated state of the airbag. If the mechanical reinforcing element rests both on the B pillar and on the C pillar at least in portions, the inflated airbag is additionally mechanically stiffened, wherein the mechanical reinforcing element is supported on the B pillar and on the C pillar.

The length of the at least one mechanical reinforcing element can be 4 times to 1.5 times, especially 3.5 times to 2 times, especially 3 times to 2.5 times of the distance between the upper edge and the lower edge of the airbag. The length of the mechanical reinforcing element thus has a higher value than the distance between the upper edge and the lower edge of the airbag. In other words, the length of the mechanical reinforcing element amounts to a multiple of the height of the airbag in the inflated state.

The mechanical reinforcing element can be connected to the airbag by at least one adhesive joint and/or at least one stitching and/or at least one fused joint. The various types of connection relate to both fastening the mechanical reinforcing element to the outer layer of the airbag and fastening the mechanical reinforcing element between the inner layer and the outer layer of the airbag.

For instance, it may be provided to form plural joints for fastening the mechanical reinforcing element to the airbag. Accordingly, it is possible that the mechanical reinforcing element is fastened to the airbag by plural juxtaposed adhesive joints.

Due to plural joints being formed, the inflating behavior of an airbag configured to include a mechanical reinforcing element is positively influenced, as the airbag can be uniformly inflated in all directions and chambers irrespective of the mechanical reinforcing element.

It is possible for the airbag to include at least two mechanical reinforcing elements, the distance between the mechanical reinforcing elements amounting to 60 to 10%, especially 50 to 15%, especially 40 to 20%, especially 30 to 25% of the distance between the upper edge and the lower edge of the airbag and, resp., the height of the airbag. Preferably both mechanical reinforcing elements are configured merely in the rear side window portion. It is imaginable that both mechanical reinforcing elements are formed and fastened between the inner layer and the outer layer of the airbag. Moreover, it is imaginable that the two mechanical reinforcing elements are formed and fastened on the outer layer of the airbag. If at least two mechanical reinforcing elements are configured, these two mechanical reinforcing elements extend substantially in parallel to each other. That is, the two reinforcing elements have substantially the same length and the same fastening position in relation to the total length of the inflatable airbag. The runs of the two mechanical reinforcing elements can deviate from each other by few degrees, or resp., by few centimeters.

Due to the configuration of an inflatable airbag comprising at least one mechanical reinforcing element, the airbag can be configured so that the lower edge has a distance from the upper edge so that the lower edge in the inflated state of the airbag substantially reaches to the lower edge of the side window. It is not necessary for the lower edge of the airbag to substantially project from the lower edge of the side window. The airbag can be designed to be smaller as regards its dimensioning of height than this is possible in the state of the art. Furthermore, if is possible to design the lower edge of the airbag to be substantially flatter than this is the case with the known curtain airbags. In order to cover the side windows to a sufficient extent in the inflated state by a curtain airbag, it is not required to design the lower edge of the airbag to have a strong curvature. Merely a configuration of the lower edge having a slight curvature is required.

Due to the configuration of the inflatable airbag of a curtain airbag according to the invention, on the one hand smaller dimensioning of the inflatable airbag is possible. On the ether hand, the exhaust volume of a gas from an inflator can be reduced. This is accompanied by weight saving as regards an airbag module to be manufactured as well as a corresponding saving of costs.

The mechanical reinforcing element is (substantially) more ridged/resistant to bending than the airbag material (airbag fabric) itself.

The mechanical reinforcing element can be made of metallic and/or plastic material and/or of composite material. When using a metal it is possible to form a thin metal strip as mechanical reinforcing element in addition, it is possible to manufacture the mechanical reinforcing element as plastic extrusion-molded part. Also the manufacture of glass-fiber reinforced plastics and/or carbon-fiber reinforced plastics is possible.

The mechanical reinforcing element is strip-shaped or elongate. The length of the reinforcing element thus amounts to a multiple of the height and, resp., width of the reinforcing element; preferably the mechanical reinforcing element has a rectangular cross-section. The corners of the mechanical reinforcing element are preferably rounded so that damage of the airbag structure is prevented. It is also possible to configure an elliptical and/or oval and/or round cross-section of the mechanical reinforcing element.

Within the scope of an independent aspect, the invention is based on the idea to state an airbag module comprising an afore-described airbag. The airbag module according to the invention further comprises an airbag inflator for inflating the airbag. Advantages similar to those illustrated already in connection with the afore-described inflatable airbag according to the invention are resulting.

As regards a vehicle occupant restraint system, the object is achieved by the features of claim 14. Hence a vehicle occupant restraint system includes an airbag according to the invention and/or an airbag module according to the invention. Advantages similar to those already illustrated in connection with the inflatable airbag according to the invention and/or with an airbag module according to the invention are resulting.

As regards a curtain airbag, the object is achieved by the features of claim 15. Accordingly, a curtain airbag includes an inflatable airbag according to the invention and/or an airbag module according to the invention. Advantages similar to those illustrated already in connection with the inflatable airbag according to the invention and/or with the airbag module according to the invention are resulting.

### BRIEF DESCRIPTION OF THE DRAWINGS

Hereinafter the invention shall be illustrated in detail by way of embodiments with reference to the enclosed schematic drawings. Further features and advantages of the invention are resulting from the following description in conjunction with these drawings in which:

FIG. 1: shows an inflatable airbag according to the invention of a curtain airbag;

FIG. 2: shows another embodiment regarding an inflatable airbag according to the invention;

FIG. 3: shows an inflatable airbag according to the invention in the rolled-in condition.

Hereinafter equal reference numerals are used for equal and equally acting parts.

### DESCRIPTION

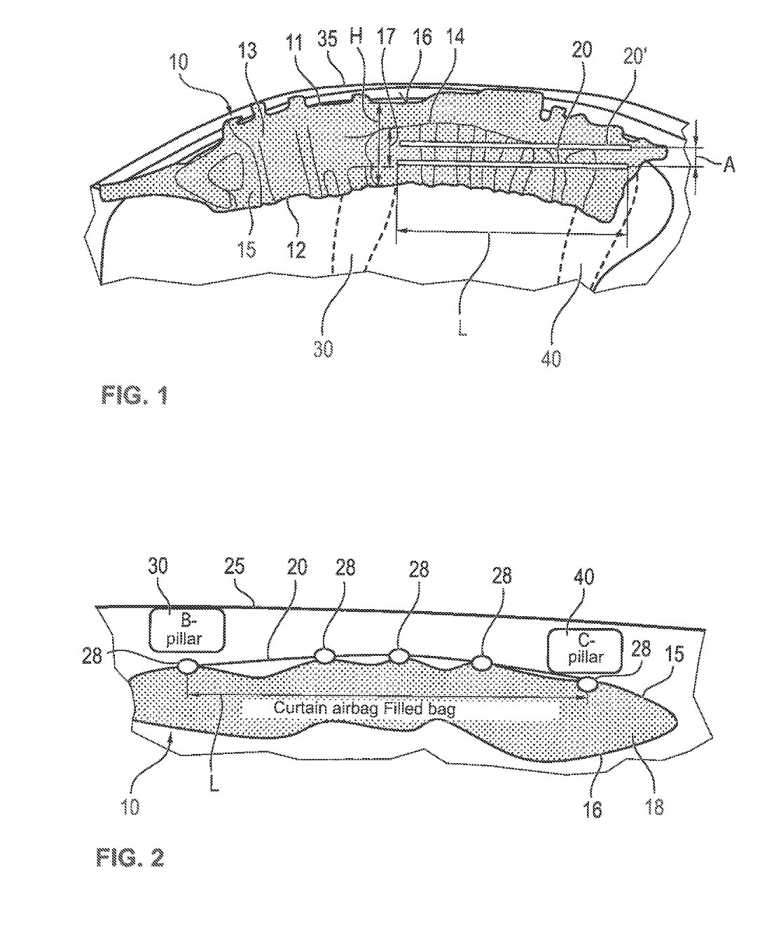

FIG. 1 shows an inflatable airbag 10 of a curtain airbag in the mounted and inflated and, resp., unrolled state. The inflatable airbag 10 includes an upper edge 11 and a lower edge 12. Between the upper edge 11 and the lower edge 12 the height H of the airbag 10 is formed.

The inflatable airbag 10 can be divided into plural sections, in the present case the inflatable airbag 10 comprises a front side window portion 13 and a rear side window portion 14. The airbag 10 is formed of at least two airbag layers. The layer of the airbag 10 visible in FIG. 1 is an outer layer 15 racing the side windows. The layer of the airbag 10 facing the interior compartment is the inner layer 16. Between the inner layer 16 and the outer layer 15 in the activated state gas flows Into the airbag and there forms a delimited airbag interior 18.

The airbag 10 includes two mechanical reinforcing elements 20, 20′. In the shown inflated state of the airbag 10, the two mechanical reinforcing elements 20, 20′ are arranged to be spaced both from the upper edge 11 and from the lower edge 12. Moreover, the two mechanical reinforcing elements 20, 20′ are arranged in a central area 17 of the height H of the airbag 10, the mechanical reinforcing elements 20, 20′ being strip-shaped. The central area 17 of the height H of the airbag 10 is the area of the airbag 10 which amounts to 20 to 30% of the height H of the airbag 10 starting from the upper edge 11. The lower one of the two mechanical reinforcing elements 20 is arranged in an area corresponding to a height of 80 to 70% of the height H of the airbag 10. The upper reinforcing element 20′ is arranged in an area which corresponds to approx. 50-60% of the height H.

The two reinforcing elements 20 and 20′ are formed and fastened between the inner layer 16 and the outer layer 16 of the airbag 10. Further, the two mechanical reinforcing elements 20 and 20′ are configured merely in the rear side window portion 14. The two reinforcing elements 20 and 20′ are furthermore configured to extend substantially in parallel to each other. Moreover, the mechanical reinforcing elements 20, 20′ extend almost in parallel to the ceiling 35 of the vehicle. The mechanical reinforcing elements 20 and 20′ have such length L that in the inflated state of the airbag 10 they cover the B pillar 30 and the C pillar 40 at least in portions. The B pillar 30 and the C pillar 40 act as support element for the mechanical reinforcing elements 20 and 20′ so that in the case of vehicle roll-over the head of a vehicle occupant is forced against a mechanical reinforcing element 20, 20′ and the reinforcing element 20, 20′ is supported on the two pillars 30 and 40. This prevents the head of a vehicle occupant from being thrown out of a possibly broken side window.

The length L of the mechanical reinforcing elements 20, 20′ preferably amounts to 4 times to 1.6 times, especially 3.5 times to 2 times, especially 3 times to 2.5 times of the distance between the upper edge 11 and the lower edge 12 of the airbag 10 or the height H. The distance A between the mechanical reinforcing elements 20 and 20′ in the present case is between 30% and 10% of the distance between the upper edge 11 and the lower edge 12 of the airbag and, resp., the height H. The central area 17 of the height H of the airbag 10 in the shown example approximately corresponds to the central area and, resp., the center of the height of the rear side window. This corresponds to the critical range in which a head of a vehicle occupant can be thrown out of a possibly cracked or destroyed side window. Apart from the bordering of a side window and, resp., the side window frame, the mechanical reinforcing element(s) form(s) an additional frame structure or an additional strip which is formed in the activated state of a curtain airbag.

The lower edge 12 of the inflatable airbag 10 is spaced apart from the upper edge 11 and, resp., the height H of the airbag is configured so that in the inflated state of the airbag 10 the lower edge 12 substantially reaches to the lower edge of the side window. The lower edge 12 moreover does not have to reach further downwards, as sufficient reinforcement of the airbag 10 is provided already due to the mechanical reinforcing elements 20 and 20′.

FIG. 2 shows another embodiment of the inflatable airbag 10 according to the invention. Accordingly, a mechanical reinforcing element 20 is fastened on the outer layer 15 of the airbag 10. The fastening is effectuated by plural joints 28 arranged to be spaced apart from each other. The mechanical reinforcing element 20 is connected to the outer layer 15 of the airbag 10 by gluing of the mechanical reinforcing element 20 to the outer layer 15 at the joints 28. The length L of the mechanical reinforcing element 20 in the present case is configured so that both the B pillar 30 and the C pillar 40 are covered at least in portions by the mechanical reinforcing element 20. Both the B pillar 30 and the C pillar 40 are covered at least up to half the cross-section by the reinforcing element 20. The B pillar 30 and the C pillar 40 form part of the vehicle frame 25.

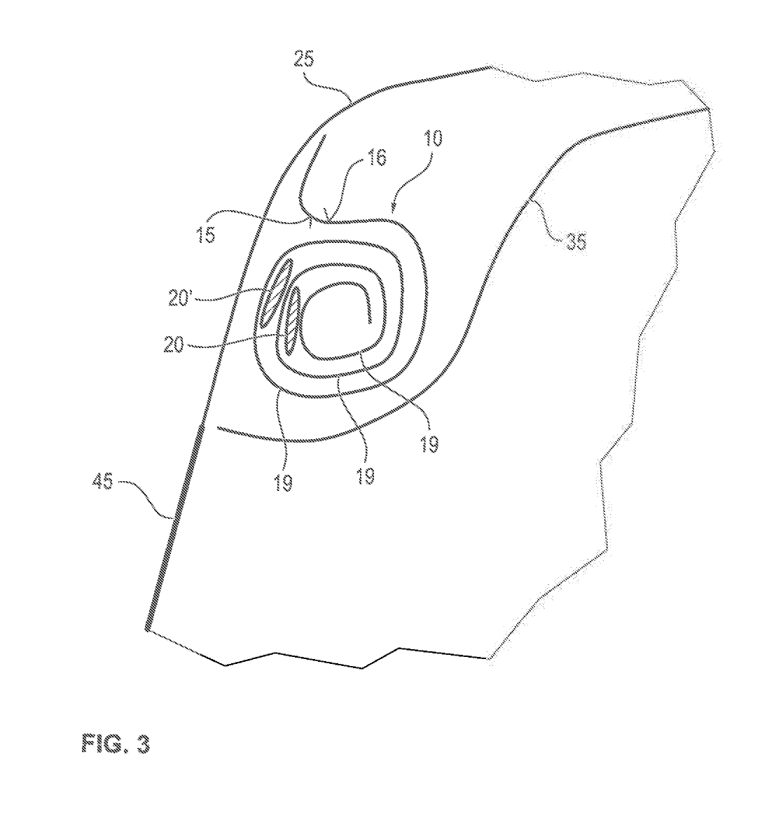

In FIG. 3, the inflatable airbag 10 according to the invention is illustrated in the rolled-in state. The latter is provided below the vehicle ceiling 35 and is connected directly or indirectly to the vehicle frame 25. The mechanical reinforcing elements 20 and 20′ are fastened to the outer layer 15 of the airbag 10 and rolled in together with the airbag 10 in the shown embodiment. In the rolled-in state each of the mechanical reinforcing elements 20 and 20′ is provided between two rolled layers 19 so that unfolding of the airbag in the direction of the side window 45 is easily possible.

### LIST OF REFERENCE NUMERALS

10 inflatable airbag
11 upper edge
12 lower edge
13 front side window portion
14 rear side window portion
15 outer layer
16 inner layer
17 central area
18 airbag interior
19 rolled layer
20, 20′ mechanical reinforcing element
25 vehicle frame
28 joint
30 B pillar
35 vehicle ceiling
40 C pillar
45 side window
H height of airbag
L length of reinforcing element
A distance between two reinforcing elements

1. An inflatable airbag (10) of a curtain airbag, comprising an upper edge (11) and a lower edge (12), comprising a front side window portion (13) and a rear side window portion (14) as well as an inner layer (16) facing the interior compartment and an outer layer (15) feeing the side windows (45), wherein
the airbag (10) includes at least one mechanical reinforcing element (20, 20′) which in the inflated state of the airbag (10) is arranged to be spaced both from the upper edge (11) and from the lower edge (12) in a central area (17) of the height (H) of the airbag (10), the mechanical reinforcing element (20, 20′) being strip-shaped.

2. The inflatable airbag (10) according to claim 1, wherein at least one mechanical reinforcing element (20, 20′) is formed and fastened between the inner layer (16) and the outer layer (15).

3. The inflatable airbag (10) according to claim 1, wherein the mechanical reinforcing element (20, 20′) is fastened to the outer layer (15).

4. The inflatable airbag (10) according to claim 1, wherein the mechanical reinforcing element (20, 20′) is formed merely in the rear side window portion (14).

5. The inflatable airbag (10) according to claim 5, wherein the mechanical reinforcing element (20, 20′) has such length (L) that in the inflated state of the airbag (10) it covers the B pillar (30) and the C pillar (40) at least in portions.

6. The inflatable airbag (10) according to claim 1, wherein the length (L) of the mechanical reinforcing element (20, 20′) amounts to 4 times to 1.5 times of the distance (H) between the upper edge (11) and the lower edge (12) of the airbag (10).

7. The inflatable airbag (10) according to claim 1, wherein the mechanical reinforcing element (20, 20′) is connected to the airbag (10) by at least one adhesive joint and/or at least one stitched joint and/or at least one fused joint.

8. The inflatable airbag (10) according to claim 1, wherein the airbag (10) includes at least two mechanical reinforcing elements (20, 20′), the distance (A) between the mechanical reinforcing elements (20, 20′) amounting to 80% to 10% of the distance (H) between the upper edge (11) and the lower edge (12) of the airbag (10).

9. The inflatable airbag according to claim 1, wherein at least two mechanical reinforcing elements (20, 20′) extend substantially in parallel to each other.

10. The inflatable airbag (10) according to claim 1, wherein the lower edge (12) has such distance (H) torn the upper edge (11) that in the inflated state of the airbag (10) the lower edge (12) substantially reaches to the lower edge of the side window (45).

11. The inflatable airbag (10) according to claim 1, wherein the rolled-in or folded state of the airbag (10) the mechanical reinforcing element (20, 20′) is arranged between two roiled or folded layers (19) of the airbag (10).

12. An airbag module comprising an airbag according to claim 1.

13. A vehicle occupant restraint system comprising an airbag according to claim 1 and comprising an airbag module according to claim 13.

14. A curtain airbag comprising an airbag according to claim 1 and comprising an airbag module according to claim 13.

15. A vehicle occupant restraint system comprising an airbag module according to claim 13.

16. A curtain airbag comprising an airbag module according to claim 13.

17. The inflatable airbag (10) according to claim 1, wherein the length (L) of the mechanical reinforcing element (20, 20′) amounts to 3.5 times to 2 times of the distance (H) between the upper edge (11) and the lower edge (12) of the airbag (10).

18. The inflatable airbag (10) according to claim 1, wherein the length (L) of the mechanical reinforcing element (20, 20′) amounts to 3 times to 2.5 times of the distance (H) between the upper edge (11) and the lower edge (12) of the airbag (10).

19. The inflatable airbag (10) according to claim 1, wherein the airbag (10) includes at least two mechanical reinforcing elements (20, 20′), the distance (A) between the mechanical reinforcing elements (20, 20′) amounting to 50% to 15% of the distance (H) between the upper edge (11) and the lower edge (12) of the airbag (10).

20. The inflatable airbag (10) according to claim 1, wherein the airbag (10) includes at least two mechanical reinforcing elements (20, 20′), the distance (A) between the mechanical reinforcing elements (20, 20′) amounting to 40% to 20% of the distance (H) between the upper edge (11) and the lower edge (12) of the airbag (10).

21. The inflatable airbag (10) according to claim 1, wherein the airbag (10) includes at least two mechanical reinforcing elements (20, 20′), the distance (A) between the mechanical reinforcing elements (20, 20′) amounting to 30% to 25% of the distance (H) between the upper edge (11) and the lower edge (12) of the airbag (10).
